(19) United States
(12) Patent Application Publication
(10) Pub. No.: US 2025/0353077 A1
(43) Pub. Date: Nov. 20, 2025

(54) GOLD NANOPARTICLE-CONTAINING COMPOSITION, GOLD NANOPARTICLE-CONTAINING COMPOSITION DISPERSION, INK, AND TONER

(71) Applicant: CANON KABUSHIKI KAISHA, Tokyo (JP)

(72) Inventors: YUTAKA YOSHIMASA, Kanagawa (JP); TAKESHI YAMAMOTO, Kanagawa (JP)

(21) Appl. No.: 19/281,393

(22) Filed: Jul. 25, 2025

Related U.S. Application Data
(63) Continuation of application No. PCT/JP2024/002223, filed on Jan. 25, 2024.

(30) Foreign Application Priority Data
Jan. 30, 2023 (JP) 2023-011951
May 11, 2023 (JP) 2023-078792

(51) Int. Cl. B22F 1/145; B22F 1/054; C09D 11/38; G03G 9/08; G03G 9/135

(52) U.S. Cl. CPC B22F 1/147; B22F 1/054; C09D 11/38; G03G 9/0819; G03G 9/1355; B22F 2301/255

(57) ABSTRACT

Provided is a gold nanoparticle-containing composition excellent in storage stability. A gold nanoparticle-containing composition (100) includes: gold nanoparticles (10); and a zwitterionic compound (20) having a structure represented by any one of the following general formulae (1) to (3), the zwitterionic compound having an HLB value of 12 or less:

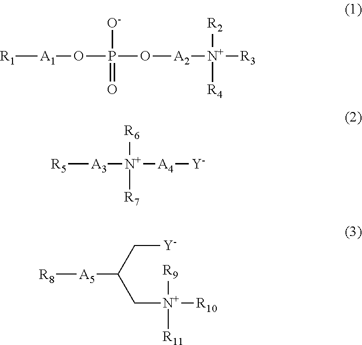

in the general formulae (1) to (3), R₁, R₅, and R₈ each independently represent an organic group, R₂ to R₄, R₆, R₇, and R₉ to R₁₁ each independently represent a hydrogen atom or an alkyl group, A₁ to A₅ each independently represent a linking group, and Y⁻ represents COO⁻ or SO₃⁻.

### CROSS-REFERENCE TO RELATED APPLICATIONS

This application is a Continuation of International Patent Application No. PCT/JP2024/002223, filed Jan. 25, 2024, which claims the benefit of Japanese Patent Application No. 2023-011951, filed Jan. 30, 2023, and Japanese Patent Application No. 2023-078792, filed May 11, 2023, all of which are hereby incorporated by reference herein in their entirety.

### BACKGROUND

### Field of the Technology

The present disclosure relates to a gold nanoparticle-containing composition, a gold nanoparticle-containing composition dispersion, an ink, and a toner.

### Description of the Related Art

Gold nanoparticles have been expected to find use in various applications, such as invisible printing, state-of-the-art electronics, and medical treatment, because the nanoparticles have unique structures, unique electrical characteristics, and unique optical characteristics. However, it has been known that the gold nanoparticles, in particular, gold nanoparticles each having an anisotropic shape, such as nanorods, nanocubes, and nanoplates, have low dispersion stability in a medium, and hence easily aggregate.

The dispersion stability of the gold nanoparticles in each of various media needs to be improved because their aggregation results in the loss of their original characteristics.

In, for example, Japanese Patent Laid-Open No. 2021-152223, there is a proposal of a gold nanorod including a silica coating layer, the nanorod being improved in dispersion stability in a medium. In addition, in Japanese Patent Laid-Open No. 2022-117406, there is a proposal of a toner including gold nanorods.

The inventors of the present invention have made an investigation on the storage stability of a dispersion of the gold nanorods each including the silica coating layer, the nanorods being proposed in Japanese Patent Laid-Open No. 2021-152223. As a result, the inventors have revealed that when the dispersion is stored under the temperature condition of 60° C., the intensity of its absorption peak reduces within 24 hours. Thus, the inventors have found that the dispersion is susceptible to improvement in terms of storage stability. In addition, in a particle having strong hydrophobicity like the toner described in Japanese Patent Laid-Open No. 2022-117406, the gold nanorods have aggregated to weaken their infrared absorbability in some cases.

### SUMMARY

Accordingly, the present disclosure is directed to provide a gold nanoparticle-containing composition excellent in storage stability. In addition, the present disclosure is directed to provide a gold nanoparticle-containing composition dispersion excellent in storage stability. In addition, the present disclosure is directed to provide an ink excellent in storage stability. Further, the present disclosure is directed to provide a toner excellent in dispersibility of gold nanoparticles.

That is, according to the present disclosure, there is provided a gold nanoparticle-containing composition including: gold nanoparticles; and a compound having a structure represented by any one of the following general formulae (1) to (3), the compound having an HLB value of 12 or less:

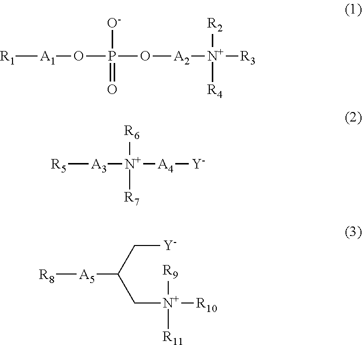

In the general formulae (1) to (3), R₁, R₅, and R₈ each independently represent an organic group, R₂ to R₄, R₆, R₇, and R₉ to R₁₁ each independently represent a hydrogen atom or an alkyl group, A₁ to A₅ each independently represent a linking group, and Y-represents COO⁻ or SO₃⁻.

Features of the present disclosure will become apparent from the following description of embodiments with reference to the attached drawings.

### BRIEF DESCRIPTION OF THE DRAWINGS

FIG. 1 is a schematic view for illustrating one embodiment of a first gold nanoparticle-containing composition of the present disclosure.

FIG. 2 is a schematic view for illustrating another embodiment of the first gold nanoparticle-containing composition of the present disclosure.

FIG. 3 is a schematic view for illustrating one embodiment of a second gold nanoparticle-containing composition of the present disclosure.

FIG. 4 is a schematic view for illustrating another embodiment of the second gold nanoparticle-containing composition of the present disclosure.

### DESCRIPTION OF THE EMBODIMENTS

The present disclosure is described in more detail below by way of exemplary embodiments. Physical property values are each a value at normal temperature (25° C.) unless otherwise stated.

### <First Gold Nanoparticle-Containing Composition>

A gold nanoparticle-containing composition (first gold nanoparticle-containing composition) of the present disclosure includes: gold nanoparticles; and a compound having a structure represented by any one of the following general formulae (1) to (3), the compound having an HLB value of 12 or less:

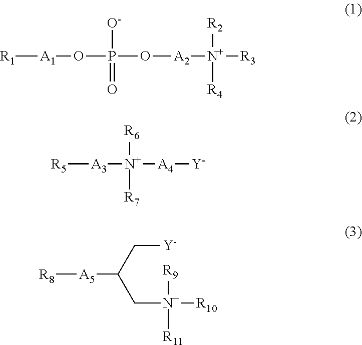

In the general formulae (1) to (3), R₁, R₅, and R₈ each independently represent an organic group, R₂ to R₄, R₆, R₇, and R₉ to R₁₁ each independently represent a hydrogen atom or an alkyl group, A₁ to A₅ each independently represent a linking group, and Y⁻ represents COO⁻ or SO₃⁻.

### (Gold Nanoparticles)

The gold nanoparticles are each a nanoparticle that contains gold as a main component, or is preferably formed substantially of gold. Examples of the shape of each of the gold nanoparticles include a spherical shape (nanosphere), a polyhedral shape, a cubic shape (nanocube), a twin-cone shape, a rod shape (nanorod), and a plate shape (nanoplate). The gold nanoparticles are preferably gold nanorods or gold nanospheres out of those nanoparticles, and may be a mixture of nanoparticles having different shapes.

The content of gold (gold element) in metals for forming each of the gold nanoparticles is preferably 50 mass % or more. The arrangement of the gold element and a metal element except the gold element may be an alloy form composited at an atomic level, or may be a core-shell form in which the nanoparticle formed substantially of gold is covered with the metal element except gold. When a substance such as a dispersant coordinates to the surface of each of the gold nanoparticles for the stabilization of dispersion, the mixture of the gold nanoparticles and the substance such as a dispersant is referred to as “gold nanoparticle-containing composition.”

The gold nanoparticles are particles each having a size of the order of nanometers (nm). The size of each of the gold nanoparticles is preferably 1 nm or more and 500 nm or less, more preferably 5 nm or more and 200 nm or less, particularly preferably 10 nm or more and 100 nm or less. The size of a particle means the maximum length of the particle. The sizes of the gold nanoparticles may be measured by, for example, observation with a scanning electron microscope (SEM), observation with a scanning transmission electron microscope (STEM), or observation with a transmission electron microscope (TEM). The maximum lengths of the gold nanoparticles may be measured with a dynamic light scattering particle size distribution-measuring apparatus (DLS). When the maximum lengths of the gold nanoparticles are measured from a SEM observation photograph, a STEM observation photograph, or a TEM observation photograph, the average of 80 values excluding values corresponding to top and bottom 10 percents of data obtained by measuring the maximum lengths of 100 arbitrary gold nanoparticles may be adopted.

The gold nanoparticles each typically have a light absorption characteristic derived from localized surface plasmon resonance (LSPR). The light absorption wavelength of each of the gold nanoparticles is changed by, for example, the size, shape, and aspect ratio (which is the ratio of a long axis to a short axis in the case of a rod-like particle, or is the ratio of the plane maximum length to a thickness in the case of a plate-like particle) thereof, and a dielectric constant therearound.

In the case of, for example, a gold nanorod, the nanorod shows two characteristic plasmon absorption bands resulting from the long axis of the rod and the short axis of the rod (bands each corresponding to the excitation of a surface plasmon band). The absorption band resulting from the short axis is present near 530 nm, and the absorption band resulting from the long axis is present at from 650 nm to 2,000 nm. The control of the aspect ratio (long axis/short axis) of the nanorod can regulate the maximum absorption wavelength thereof. The aspect ratio of the gold nanorod is typically 1.5 or more.

Gold nanospheres may be prepared in accordance with a conventionally known method. The gold nanospheres may be obtained by, for example, adding sodium borohydride (NaBH₄) to chloroauric acid (HAuCl₄) in an aqueous solution, and subjecting the mixture to a reaction for 24 hours. A surfactant such as cetyltrimethylammonium bromide (CTAB) may be used as required.

Gold nanorods may be prepared in accordance with, for example, a method proposed by B. Nikoobakft and M. A. El-Sayed (Chemistry of Materials, 2003, Vol. 15, pp. 1957-1962). The gold nanorods may be obtained by, for example, reducing chloroauric acid (HAuCl₄) with ascorbic acid in an aqueous solution containing two kinds of surfactants (hexadecyltrimethylammonium bromide and benzyldimethylhexadecylammonium chloride).

In addition, the following method is available: gold nanorod particles are synthesized by reducing a gold ion in an aqueous solution containing an excess of cetyltrimethylammonium bromide (CTAB) serving as a quaternary ammonium salt. In the method, first, an aqueous solution of CTAB is added to an aqueous solution of chloroauric acid tetrahydrate, and sodium borohydride is further added to the mixture to prepare a solution containing seed particles. Next, a mixed solution of silver nitrate, chloroauric acid tetrahydrate, L-ascorbic acid, and CTAB is added to the prepared solution, and the mixture is held for a certain time period. Alternatively, the mixed solution is added little by little thereto. Thus, the seed particles serving as cores are anisotropically grown with ease, and hence the gold nanorods can be obtained.

At the time of the growth of the seed particles, the addition of benzyldimethylhexadecylammonium chloride can provide gold nanorods each having a large aspect ratio. In addition, the gold nanorods each having a large aspect ratio may be obtained by reducing gold with sodium borohydride serving as a strong reducing agent, and then reducing the resultant with triethylamine serving as a weak reducing agent.

An aspect ratio distribution may be adjusted as required by purifying the gold nanorods. Generally known methods may each be adopted for the purification of the gold nanorods. The gold nanorods may be purified by, for example, a density gradient ultracentrifugation method. Specifically, first, mixed solutions of sucrose and CTAB having different concentrations are prepared, and are superposed in a concentration gradient order in a centrifuge tube. The sample of the gold nanorods is superposed thereon, and then the resultant is subjected to ultracentrifugation treatment. Thus, gold nanorods having a small standard deviation a and a narrower aspect ratio distribution can be obtained.

A surfactant may be used as a dispersant at the time of the preparation of the gold nanoparticles. Examples of the surfactant may include cetyltrimethylammonium bromide (CTAB), benzyldimethylhexadecylammonium chloride (BDAC), dodecyltrimethylammonium chloride (DTAB), and tetradecyltrimethylammonium bromide (TTAB).

### (Zwitterionic Compound)

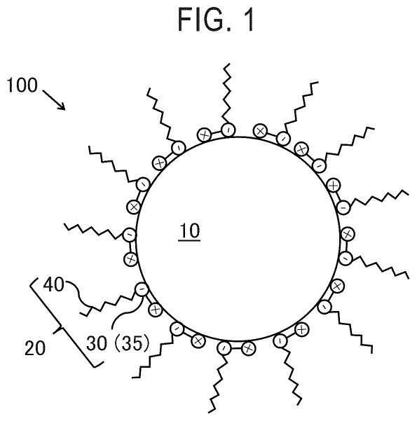

FIG. 1 is a schematic view for illustrating one embodiment of the first gold nanoparticle-containing composition of the present disclosure. As illustrated in FIG. 1, the compound (zwitterionic compound 20) having a structure represented by any one of the following general formulae (1) to (3), the compound having an HLB value of 12 or less, strongly coordinates to the surface of a gold nanoparticle 10 through a bonding portion 30 (hydrophilic portion 35). Thus, a gold nanoparticle-containing composition 100 of this embodiment is formed. The bonding portion 30 has positive charge (+) and negative charge (−) arranged at positions that are not adjacent to each other. In addition, the entirety of a molecule of the zwitterionic compound 20 is free of any charge. The gold nanoparticles are typically synthesized in a liquid containing a surfactant such as cetyltrimethylammonium bromide (CTAB). Accordingly, CTAB or the like coordinates to the surface of each of the gold nanoparticles after the synthesis. Recent research has found that a difference in CTAB density on the surface of each of the gold nanoparticles causes a potential gradient on the gold nanoparticle (Kim et al., SCIENCE ADVANCES 2018, 4(2), e1700682). The zwitterionic compound 20 may strongly coordinate in accordance with the potential gradient on the surface of the gold nanoparticle 10 because the compound has both of positive charge and negative charge. It is assumed that as a result of the foregoing, high dispersion stability is exhibited.

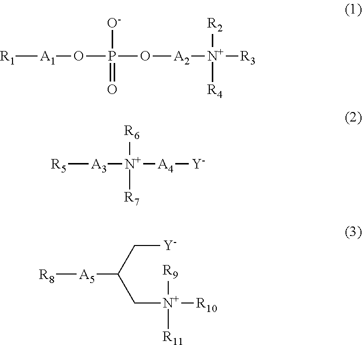

In the general formulae (1) to (3), R₁, R₅, and R₈ each independently represent an organic group, R₂ to R₄, R₆, R₇, and R₉ to R₁₁ each independently represent a hydrogen atom or an alkyl group, A₁ to A₅ each independently represent a linking group, and Y-represents COO⁻ or SO₃⁻.

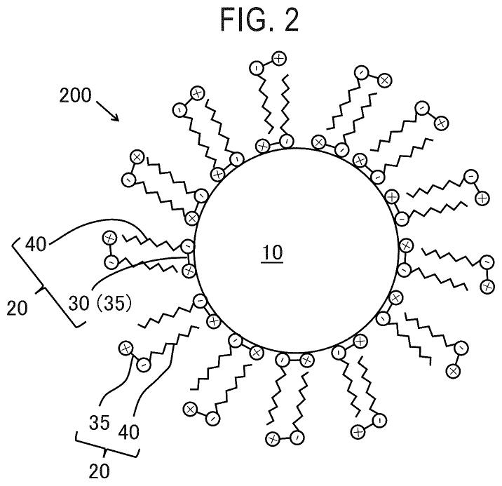

At least part of the zwitterionic compound preferably coordinates to the surface of each of the gold nanoparticles. As illustrated in FIG. 1, the zwitterionic compound 20 has a hydrophobic portion 40 and the bonding portion 30 (hydrophilic portion 35). When a dispersion medium is hydrophobic, the dispersion of the gold nanoparticle 10 can be effectively stabilized by: strongly coordinating the bonding portion 30 toward the surface of the gold nanoparticle 10; and directing the hydrophobic portion 40 toward the dispersion medium. Meanwhile, when the dispersion medium is hydrophilic, it is assumed that as illustrated in FIG. 2, the zwitterionic compound 20 forms a double layer to arrange the hydrophilic portion 35 on the outermost surface of the nanoparticle. It is conceivable that as a result of the foregoing, a gold nanoparticle-containing composition 200 in which the dispersion of the gold nanoparticle 10 is stabilized is formed.

The first gold nanoparticle-containing composition may be prepared in accordance with, for example, the following procedure. First, a poor solvent is added as required to a dispersion containing the gold nanoparticles and the zwitterionic compound, and then the mixture is subjected to centrifugation treatment. Next, the produced sediment is dried. Thus, the target first gold nanoparticle-containing composition can be obtained.

Examples of a method of coordinating at least part of the zwitterionic compound to the surface of each of the gold nanoparticles may include: a method including causing the zwitterionic compound to act on each of the gold nanoparticles to exchange the compound with a surfactant to be described later; and a method including causing the gold nanoparticles and the zwitterionic compound to coexist. In the case of the method including exchanging the compound with the surfactant, an excessive surfactant that has been liberated can be removed by centrifugation.

In the general formulae (1) to (3), examples of the organic group represented by each of R₁, R₅, and R₈ may include: a linear, branched, or cyclic alkyl group that may have a substituent; a linear, branched, or cyclic heteroalkyl group that may have a substituent; an aryl group that may have a substituent; a heteroaryl group that may have a substituent; an aralkyl group that may have a substituent; and a heteroaralkyl group that may have a substituent.

In the general formulae (1) to (3), the alkyl group represented by each of R₂ to R₄, R₆, R₇, and R₉ to R₁₁ is preferably an alkyl group having 1 to 18 carbon atoms. Examples of the alkyl group having 1 to 18 carbon atoms may include a methyl group, an ethyl group, a n-propyl group, an isopropyl group, a n-butyl group, a n-octyl group, a 2-ethylhexyl group, a dodecyl group, and an octadecyl group. Those alkyl groups may each be further substituted, or may be bonded to each other to form a ring.

In the general formula (1), A₁ represents a linking group that bonds R₁ and a phosphoric acid ester moiety to each other. Examples of the linking group A₁ may include a carbonyl group, an alkylene group, an arylene group, and —COOR₂₀— (R₂₀ represents an alkylene group having 1 to 4 carbon atoms). A₁ may represent a single bond. That is, R₁ may be directly bonded to the phosphoric acid ester moiety.

The alkylene group serving as the linking group A₁ may be linear or branched, and is preferably an alkylene group having 1 to 4 carbon atoms. Examples of the alkylene group having 1 to 4 carbon atoms may include a methylene group, an ethylene group, a propylene group, and various butylene groups.

Examples of the arylene group serving as the linking group A₁ may include a 1,2-phenylene group, a 1,3-phenylene group, a 1,4-phenylene group, a naphthalene-1,4-diyl group, a naphthalene-1,5-diyl group, and a naphthalene-2,6-diyl group.

A carbonyl group in “—COOR₂₀—” serving as the linking group A₁ is bonded to a moiety except the phosphoric acid ester moiety. The alkylene group having 1 to 4 carbon atoms that is represented by R₂₀ may be linear or branched.

The linking group A₁ may be further substituted with any other functional group. From the viewpoints of, for example, the availability of a raw material and the ease of production, the linking group A₁ is preferably a carbonyl group or “—COOR₂₀—”.

In the general formula (1), A₂ represents a linking group that bonds the phosphoric acid ester moiety and a quaternary ammonium moiety to each other. Examples of the linking group A₂ may include an alkylene group and an arylene group. The alkylene group serving as the linking group A₂ may be linear or branched, and is preferably an alkylene group having 1 to 4 carbon atoms. Examples of the alkylene group having 1 to 4 carbon atoms may include a methylene group, an ethylene group, a propylene group, and various butylene groups.

Examples of the arylene group serving as the linking group A₂ may include a 1,2-phenylene group, a 1,3-phenylene group, a 1,4-phenylene group, a naphthalene-1,4-diyl group, a naphthalene-1,5-diyl group, and a naphthalene-2,6-diyl group.

The linking group A₂ may be further substituted with any other functional group. From the viewpoints of, for example, the availability of a raw material and the ease of production, the linking group A₂ is preferably an alkylene group, such as a methylene group or an ethylene group.

In the general formula (2), A₃ represents a linking group that bonds R₅ and a quaternary ammonium moiety to each other. Examples of the linking group A₃ may include an alkylene group, an arylene group, an aralkylene group, —COOR₂₁—, —CONHR₂₁—, and —OR₂₁— (R₂₁ represents an alkylene group or an arylene group). A₃ may represent a single bond. That is, R₈ may be directly bonded to the quaternary ammonium moiety.

The alkylene group serving as the linking group A₃ may be linear or branched, and is preferably an alkylene group having 1 to 4 carbon atoms. Examples of the alkylene group having 1 to 4 carbon atoms may include a methylene group, an ethylene group, a propylene group, and various butylene groups.

Examples of the arylene group serving as the linking group A₃ may include a 1,2-phenylene group, a 1,3-phenylene group, a 1,4-phenylene group, a naphthalene-1,4-diyl group, a naphthalene-1,5-diyl group, and a naphthalene-2,6-diyl group.

The aralkylene group serving as the linking group A₃ may be, for example, an aralkylene group having 7 to 15 carbon atoms. In each of “—COOR₂₁—”, “—CONHR₂₁—”, and “—OR₂₁—” serving as the linking group A₃, the alkylene group represented by R₂₁ may be linear or branched, and is preferably an alkylene group having 1 to 4 carbon atoms. Examples of the alkylene group having 1 to 4 carbon atoms may include a methylene group, an ethylene group, a propylene group, and various butylene groups. In each of “—COOR₂₁—”, “—CONHR₂₁—”, and “—OR₂₁—” serving as the linking group A₃, examples of the arylene group represented by R₂₁ may include a 1,2-phenylene group, a 1,3-phenylene group, a 1,4-phenylene group, a naphthalene-1,4-diyl group, a naphthalene-1,5-diyl group, and a naphthalene-2,6-diyl group.

The linking group A₃ may be further substituted with any other functional group. From the viewpoints of, for example, the availability of a raw material and the ease of production, the linking group A₃ is preferably —COOR₂₁— or —CONHR₂₁—.

In the general formula (2), A₄ represents a linking group that bonds the quaternary ammonium moiety and Y⁻ serving as a counter anion moiety thereof to each other. Examples of the linking group A₄ may include an alkylene group and an arylene group.

In the general formula (3), A₅ represents a linking group that bonds R₈ and a zwitterionic moiety to each other. Examples of the linking group A₅ may include an alkylene group, an arylene group, an aralkylene group, —COOR₂₂—, —CONHR₂₂—, and —OR₂₂— (R₂₂ represents an alkylene group or an arylene group). A₅ may represent a single bond. That is, R₈ may be directly bonded to the zwitterionic moiety.

The alkylene group serving as the linking group A₅ may be linear or branched, and is preferably an alkylene group having 1 to 4 carbon atoms. Examples of the alkylene group having 1 to 4 carbon atoms may include a methylene group, an ethylene group, a propylene group, and various butylene groups.

Examples of the arylene group serving as the linking group A₅ may include a 1,2-phenylene group, a 1,3-phenylene group, a 1,4-phenylene group, a naphthalene-1,4-diyl group, a naphthalene-1,5-diyl group, and a naphthalene-2,6-diyl group. From the viewpoints of, for example, the availability of a raw material and the ease of production, the linking group A₅ is preferably an alkylene group, such as a methylene group, an ethylene group, or a propylene group.

In each of the general formulae (2) and (3), Y⁻ represents the counter anion of the quaternary ammonium moiety, and represents COO⁻ or SO₃⁻. The zwitterionic compound preferably has a structure represented by the formula (1), or a structure, which is represented by the formula (2) or the formula (3) and in which Y⁻ represents SO₃⁻.

An HLB value is a physical property value representing a balance (hydrophile-lipophile balance) between the hydrophilic portion and hydrophobic portion of a molecule, and has a value of from 0 to 20. As the HLB value becomes smaller, the hydrophobicity of the molecule becomes higher, and as the HLB value becomes larger, the hydrophilicity thereof becomes higher. The term “HLB value” as used herein refers to a value calculated in accordance with “Griffin's equation” described below.

$$HLB value = \{ ( 100 / 5 ) \times mass of hydrophilic portion \} / ( mass of hydrophilic portion + mass of hydrophobic portion )$$

In the general formula (1), A₁ and R₁ represent a hydrophobic portion, and a portion except A₁ and R₁ is a hydrophilic portion. In the general formula (2), A₃ and R₅ represent a hydrophobic portion, and a portion except A₃ and R₅ is a hydrophilic portion. In the general formula (3), N⁺R₉R₁₀R₁₁ and Y⁻ represent a hydrophilic portion, and a portion except N⁺R₉R₁₀R₁₁ and Y⁻ is a hydrophobic portion.

The HLB value is typically a physical property value considered to be an indicator of a balance between the hydrophilic portion and hydrophobic portion of a nonionic surfactant. The hydrophilicity of a hydrophilic group in an ionic surfactant is significantly high as compared to the hydrophilicity of a hydrophilic group in the nonionic surfactant. Accordingly, the degree of hydrophilicity per unit mass of the ionic surfactant varies depending on the kind of a hydrophilic group thereof. Accordingly, it has been generally considered that there exists no method of calculating the HLB value of the ionic surfactant. However, it is assumed that hydrophilic groups in the above-mentioned zwitterionic compound are relatively approximate in degree of hydrophilicity per unit mass to each other. Accordingly, it is conceivable that the degrees of the hydrophilicity and hydrophobicity of the zwitterionic compound can be compared to each other by the HLB value calculated in accordance with Griffin's equation described above.

The content of the zwitterionic compound with respect to 100 parts by mass of the gold nanoparticles in the first gold nanoparticle-containing composition is preferably 25 parts by mass or more and 5,000 parts by mass or less, more preferably 50 parts by mass or more and 2,500 parts by mass or less. In addition, the content is particularly preferably 75 parts by mass or more and 1,250 parts by mass or less. When the content of the zwitterionic compound with respect to 100 parts by mass of the gold nanoparticles is less than 25 parts by mass, an improving effect on the storage stability of the composition may be somewhat insufficient. Meanwhile, when the content of the zwitterionic compound with respect to 100 parts by mass of the gold nanoparticles is more than 5,000 parts by mass, the solubility or dispersibility of the zwitterionic compound in the dispersion medium may reduce, and hence the improving effect on the storage stability may be somewhat insufficient.

### <Second Gold Nanoparticle-Containing Composition>

A gold nanoparticle-containing composition (second gold nanoparticle-containing composition) of the present disclosure includes: gold nanoparticles; and a polymer compound having a structure represented by any one of the following general formulae (4) to (6):

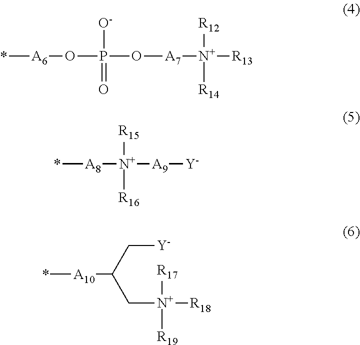

In the general formulae (4) to (6), R₁₂ to R₁₉ each independently represent a hydrogen atom or an alkyl group, A₆ to A₁₀ each independently represent a linking group, Y⁻ represents COO⁻ or SO₃⁻, and * represents a bonding site to a polymer main chain.

### (Polymer Compound)

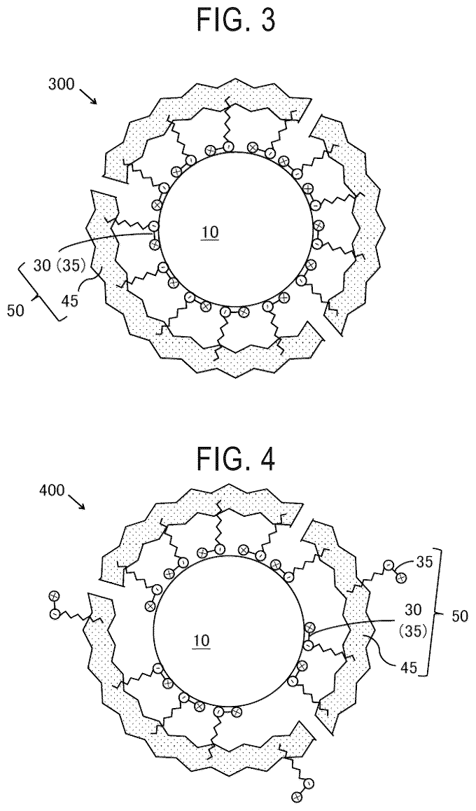

FIG. 3 is a schematic view for illustrating one embodiment of the second gold nanoparticle-containing composition of the present disclosure. As illustrated in FIG. 3, a polymer compound 50 having a structure represented by any one of the general formulae (4) to (6) strongly coordinates to the surface of the gold nanoparticle 10 through the bonding portion 30 (hydrophilic portion 35). Thus, a gold nanoparticle-containing composition 300 of this embodiment is formed. The bonding portion 30 has positive charge (+) and negative charge (−) arranged at positions that are not adjacent to each other. In addition, the entirety of a molecule of the polymer compound 50 is free of any charge. The gold nanoparticles are typically synthesized in a liquid containing a surfactant such as cetyltrimethylammonium bromide (CTAB). Accordingly, CTAB or the like coordinates to the surface of each of the gold nanoparticles after the synthesis. Recent research has found that a difference in CTAB density on the surface of each of the gold nanoparticles causes a potential gradient on the gold nanoparticle (Kim et al., SCIENCE ADVANCES 2018, 4(2), e1700682). The polymer compound 50 may strongly coordinate in accordance with the potential gradient on the surface of the gold nanoparticle 10 because the compound has both of positive charge and negative charge. It is assumed that as a result of the foregoing, high dispersion stability is exhibited.

At least part of the polymer compound preferably coordinates to the surface of each of the gold nanoparticles.

As illustrated in FIG. 3, the polymer compound 50 has a hydrophobic polymer main chain 45 and the bonding portion 30 (hydrophilic portion 35). When a dispersion medium is hydrophobic, the dispersion of the gold nanoparticle 10 can be effectively stabilized by: strongly coordinating the bonding portion 30 toward the surface of the gold nanoparticle 10; and directing the polymer main chain 45 toward the dispersion medium. Meanwhile, when the dispersion medium is hydrophilic, it is assumed that as illustrated in FIG. 4, part of the hydrophilic portion 35 of the polymer compound 50 coordinates to the surface of the gold nanoparticle 10, and the remaining hydrophilic portion 35 is directed toward the dispersion medium. That is, it is conceivable that the polymer compound 50 is arranged in accordance with the degree of hydrophilicity/hydrophobicity of the dispersion medium, and thus a gold nanoparticle-containing composition 400 that is stabilized in dispersion in each of various dispersion media is formed.

In the general formula (4), the alkyl group represented by each of R₁₂ to R₁₉ is preferably an alkyl group having 1 to 18 carbon atoms. Examples of the alkyl group having 1 to 18 carbon atoms may include a methyl group, an ethyl group, a n-propyl group, an isopropyl group, a n-butyl group, a n-octyl group, a 2-ethylhexyl group, a dodecyl group, and an octadecyl group. Those alkyl groups may each be further substituted, or may be bonded to each other to form a ring.

In the general formula (4), A₆ represents a linking group that bonds a polymer main chain and a phosphoric acid ester moiety to each other.

Examples of the linking group A₆ may include a carbonyl group, an alkylene group, an arylene group, and —COOR₂₃— (R₂₃ represents an alkylene group having 1 to 4 carbon atoms). A₆ may represent a single bond. That is, the polymer main may be directly bonded to the phosphoric acid ester moiety.

The alkylene group serving as the linking group A₆ may be linear or branched, and is preferably an alkylene group having 1 to 4 carbon atoms. Examples of the alkylene group having 1 to 4 carbon atoms may include a methylene group, an ethylene group, a propylene group, and various butylene groups.

Examples of the arylene group serving as the linking group A₆ may include a 1,2-phenylene group, a 1,3-phenylene group, a 1,4-phenylene group, a naphthalene-1,4-diyl group, a naphthalene-1,5-diyl group, and a naphthalene-2,6-diyl group.

A carbonyl group in “—COOR₂₃—” serving as the linking group A₆ is bonded to a moiety except the phosphoric acid ester moiety. The alkylene group having 1 to 4 carbon atoms that is represented by R₂₃ may be linear or branched.

The linking group A₆ may be further substituted with any other functional group. From the viewpoints of, for example, the availability of a raw material and the ease of production, the linking group A₆ is preferably a carbonyl group or “—COOR₂₃—”.

In the general formula (4), A₇ represents a linking group that bonds the phosphoric acid ester moiety and a quaternary ammonium moiety to each other. Examples of the linking group A₇ may include an alkylene group and an arylene group. The alkylene group serving as the linking group A₇ may be linear or branched, and is preferably an alkylene group having 1 to 4 carbon atoms. Examples of the alkylene group having 1 to 4 carbon atoms may include a methylene group, an ethylene group, a propylene group, and various butylene groups.

Examples of the arylene group serving as the linking group A₇ may include a 1,2-phenylene group, a 1,3-phenylene group, a 1,4-phenylene group, a naphthalene-1,4-diyl group, a naphthalene-1,5-diyl group, and a naphthalene-2,6-diyl group.

The linking group A₇ may be further substituted with any other functional group. From the viewpoints of, for example, the availability of a raw material and the ease of production, the linking group A₇ is preferably an alkylene group, such as a methylene group or an ethylene group.

In the general formula (5), A₈ represents a linking group that bonds a polymer main chain and a quaternary ammonium moiety to each other. Examples of the linking group A₈ may include an alkylene group, an arylene group, an aralkylene group, —COOR₂₄—, —CONHR₂₄—, and —OR₂₄— (R₂₄ represents an alkylene group or an arylene group). A₈ may represent a single bond. That is, the polymer main chain may be directly bonded to the quaternary ammonium moiety.

The alkylene group serving as the linking group A₈ may be linear or branched, and is preferably an alkylene group having 1 to 4 carbon atoms. Examples of the alkylene group having 1 to 4 carbon atoms may include a methylene group, an ethylene group, a propylene group, and various butylene groups.

Examples of the arylene group serving as the linking group A₈ may include a 1,2-phenylene group, a 1,3-phenylene group, a 1,4-phenylene group, a naphthalene-1,4-diyl group, a naphthalene-1,5-diyl group, and a naphthalene-2,6-diyl group.

The aralkylene group serving as the linking group A₈ may be, for example, an aralkylene group having 7 to 15 carbon atoms. In each of “—COOR₂₄—”, “—CONHR₂₄—”, and “—OR₂₄—” serving as the linking group A₈, the alkylene group represented by R₂₄ may be linear or branched, and is preferably an alkylene group having 1 to 4 carbon atoms. Examples of the alkylene group having 1 to 4 carbon atoms may include a methylene group, an ethylene group, a propylene group, and various butylene groups. In each of “—COOR₂₄—”, “—CONHR₂₄—”, and “—OR₂₄—” serving as the linking group A₈, examples of the arylene group represented by R₂₄ may include a 1,2-phenylene group, a 1,3-phenylene group, a 1,4-phenylene group, a naphthalene-1,4-diyl group, a naphthalene-1,5-diyl group, and a naphthalene-2,6-diyl group.

The linking group A₈ may be further substituted with any other functional group. From the viewpoints of, for example, the availability of a raw material and the ease of production, the linking group A₈ is preferably —COOR₂₄— or —CONHR₂₄—.

In the general formula (5), A₉ represents a linking group that bonds the quaternary ammonium moiety and Y⁻ serving as a counter anion moiety thereof to each other. Examples of the linking group A₉ may include an alkylene group and an arylene group.

In the general formula (6), A₁₀ represents a linking group that bonds a polymer main chain and a zwitterionic moiety to each other. Examples of the linking group A₁₀ may include an alkylene group, an arylene group, an aralkylene group, —COOR₂₅—, —CONHR₂₅—, and —OR₂₅— (R₂₅ represents an alkylene group or an arylene group). A₁₀ may represent a single bond. That is, the polymer main chain may be directly bonded to the zwitterionic moiety.

The alkylene group serving as the linking group A₁₀ may be linear or branched, and is preferably an alkylene group having 1 to 4 carbon atoms. Examples of the alkylene group having 1 to 4 carbon atoms may include a methylene group, an ethylene group, a propylene group, and various butylene groups. Examples of the arylene group serving as the linking group A₁₀ may include a 1,2-phenylene group, a 1,3-phenylene group, a 1,4-phenylene group, a naphthalene-1,4-diyl group, a naphthalene-1,5-diyl group, and a naphthalene-2,6-diyl group. From the viewpoints of, for example, the availability of a raw material and the ease of production, the linking group A₁₀ is preferably an alkylene group, such as a methylene group, an ethylene group, or a propylene group.

In each of the general formulae (5) and (6), Y⁻ represents the counter anion of the quaternary ammonium moiety, and represents COO⁻ or SO₃⁻. The polymer compound preferably has a structure represented by the formula (4), or a structure, which is represented by the formula (5) or the formula (6) and in which Y⁻ represents SO₃⁻.

The polymer compound preferably has a polymer main chain including a unit represented by the following general formula (7):

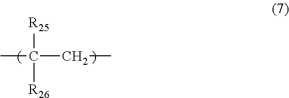

In the general formula (7), R₂₅ represents a hydrogen atom or an alkyl group, and R₂₆ represents an alkyl group, a carboxylic acid ester group, a carboxylic acid amide group, an alkoxy group, or an aryl group.

In the general formula (7), the alkyl group represented by R₂₅ may be, for example, an alkyl group having 1 to 4 carbon atoms. Examples of the alkyl group having 1 to 4 carbon atoms may include a methyl group, an ethyl group, a n-propyl group, an isopropyl group, and a n-butyl group. From the viewpoint of, for example, polymerizability, R₂₅ preferably represents a hydrogen atom or a methyl group.

In the general formula (7), the alkyl group represented by R₂₆ may be, for example, an alkyl group having 1 to 30 carbon atoms. Examples of the alkyl group having 1 to 30 carbon atoms may include a methyl group, an ethyl group, a n-propyl group, a n-butyl group, a n-hexyl group, a n-decyl group, a n-hexadecyl group, an octadecyl group, a docosyl group, and a triacontyl group.

In the general formula (7), the carboxylic acid ester group represented by R₂₆ may be, for example, —COOR₂₇ (R₂₇ represents an alkyl group having 1 to 30 carbon atoms, a phenyl group, or a hydroxyalkyl group having 1 to 30 carbon atoms). Examples of the carboxylic acid ester group may include a methyl ester group, an ethyl ester group, a n-propyl ester group, an isopropyl ester group, a n-butyl ester group, a tert-butyl ester group, an octyl ester group, a 2-ethylhexyl ester group, a dodecyl ester group, an octadecyl ester group, a docosyl ester group, a triacontyl ester group, a phenyl ester group, and a 2-hydroxyethyl ester group.

In the general formula (7), the carboxylic acid amide group represented by R₂₆ may be, for example, —CO—NR₂₈R₂₉ (R₂₈ and R₂₉ each independently represent hydrogen, an alkyl group having 1 to 30 carbon atoms, or a phenyl group). Examples of the carboxylic acid amide group may include an N-methylamide group, an N,N-dimethylamide group, an N,N-diethylamide group, an N-isopropylamide group, an N-tert-butylamide group, an N-n-decylamide group, an N-n-hexadecylamide group, an N-octadecylamide group, an N-docosylamide group, an N-triacontylamide group, and an N-phenylamide group.

In the general formula (7), examples of the alkoxy group represented by R₂₆ may include an alkoxy group having 1 to 30 carbon atoms and a hydroxyalkoxy group having 1 to 30 carbon atoms. Examples of the alkoxy group may include a methoxy group, an ethoxy group, a n-propoxy group, an isopropoxy group, a n-butoxy group, a n-hexyloxy group, a cyclohexyloxy group, a n-octyloxy group, a 2-ethylhexyloxy group, a dodecyloxy group, an octadecyloxy group, a docosyloxy group, a triacontyloxy group, and a 2-hydroxyethoxy group.

In the general formula (7), examples of the aryl group represented by R₂₆ may include a phenyl group, a 1-naphthyl group, and a 2-naphthyl group.

R₂₆ in the general formula (7) may be further substituted. Examples of the substituent may include: alkoxy groups, such as a methoxy group and an ethoxy group; amino groups, such as an N-methylamino group and an N,N-dimethylamino group; acyl groups such as an acetyl group; and halogen atoms, such as a fluorine atom and a chlorine atom.

The substituents of R₂₅ and R₂₆ in the general formula (7) may each be appropriately selected from the above-mentioned various substituents in accordance with applications. For example, when a dispersion medium having high hydrophobicity is used, a substituent having a long-chain alkyl group is preferably selected for improving the dispersibility and stability of the polymer compound.

The content (mol %) of the unit represented by the general formula (7) in the polymer compound is preferably 30 mol % or more and 98 mol % or less, more preferably 40 mol % or more and 97 mol % or less with respect to all units. In addition, the content is particularly preferably 50 mol % or more and 90 mol % or less. When the content of the unit represented by the general formula (7) in the polymer compound is set within the above-mentioned ranges, the coordination of the polymer compound to the surface of each of the gold nanoparticles is stabilized, and hence the dispersibility of the gold nanoparticles can be further improved.

The content of the polymer compound with respect to 100 parts by mass of the gold nanoparticles in the second gold nanoparticle-containing composition is preferably 25 parts by mass or more and 5,000 parts by mass or less, more preferably 50 parts by mass or more and 2,500 parts by mass or less. In addition, the content is particularly preferably 75 parts by mass or more and 1,250 parts by mass or less. When the content of the polymer compound with respect to 100 parts by mass of the gold nanoparticles is less than 25 parts by mass, an improving effect on the storage stability of the composition may be somewhat insufficient. Meanwhile, when the content of the polymer compound with respect to 100 parts by mass of the gold nanoparticles is more than 5,000 parts by mass, the solubility or dispersibility of the polymer compound in the dispersion medium may reduce, and hence the improving effect on the storage stability may be somewhat insufficient.

The weight-average molecular weight of the polymer compound is preferably 1,000 or more and 100,000 or less, more preferably 2,000 or more and 50,000 or less. When the zwitterionic compound and the polymer compound are used in equal amounts each with respect to the gold nanoparticles, a case in which the polymer compound is used exhibits a higher improving effect on the storage stability of the gold nanoparticle-containing composition or a gold nanoparticle-containing composition dispersion to be obtained.

### <Gold Nanoparticle-Containing Composition Dispersion>

A gold nanoparticle-containing composition dispersion (first gold nanoparticle-containing composition dispersion) of the present disclosure includes a dispersion medium and a gold nanoparticle-containing composition dispersed in the dispersion medium. In addition, the gold nanoparticle-containing composition is the above-mentioned first gold nanoparticle-containing composition including: the gold nanoparticles; and the compound having a structure represented by any one of the general formulae (1) to (3), the compound having an HLB value of 12 or less. That is, the first gold nanoparticle-containing composition dispersion may be obtained by dispersing the above-mentioned first gold nanoparticle-containing composition in the dispersion medium in accordance with an ordinary method. The first gold nanoparticle-containing composition dispersion may be returned to the first gold nanoparticle-containing composition by removing the dispersion medium through drying or the like.

In addition, a gold nanoparticle-containing composition dispersion (second gold nanoparticle-containing composition dispersion) of the present disclosure includes a dispersion medium and a gold nanoparticle-containing composition dispersed in the dispersion medium. In addition, the gold nanoparticle-containing composition is the above-mentioned second gold nanoparticle-containing composition including: the gold nanoparticles; and the polymer compound having a structure represented by any one of the general formulae (4) to (6). That is, the second gold nanoparticle-containing composition dispersion may be obtained by dispersing the above-mentioned second gold nanoparticle-containing composition in the dispersion medium in accordance with an ordinary method. The second gold nanoparticle-containing composition dispersion may be returned to the second gold nanoparticle-containing composition by removing the dispersion medium through drying or the like.

The content (mass %) of the gold nanoparticles in the gold nanoparticle-containing composition dispersion is preferably 0.001 mass % or more and 10 mass % or less, more preferably 0.005 mass % or more and 5 mass % or less with respect to the total mass of the dispersion. When the content of the gold nanoparticles is less than 0.001 mass %, the dispersion may hardly express its characteristics such as infrared absorbability. Meanwhile, when the content of the gold nanoparticles is more than 10 mass %, an improving effect on the storage stability of the dispersion may reduce to some extent.

The content of the gold nanoparticles in the gold nanoparticle-containing composition dispersion may be measured by thermogravimetric differential thermal analysis (TG-DTA).

### (Dispersion Medium)

Examples of the dispersion medium may include: water; alcohols, such as methanol, ethanol, propanol, hexanol, and ethylene glycol; aromatic hydrocarbons, such as xylene and toluene; hydrocarbons such as hexane; alicyclic hydrocarbons such as cyclohexane; ketones, such as acetone and methyl ethyl ketone; esters, such as ethyl acetate and butyl acetate; ethers such as ethylene glycol monobutyl ether; dimethyl sulfoxide; and dimethylformamide. Those dispersion media may be used as a mixture thereof as required.

### (Additives)

The gold nanoparticle-containing composition dispersion may include various additives as required. Examples of the additives may include a surfactant, a pH adjuster, a surface slipping agent, a rust inhibitor, an antiseptic, a mildew-proofing agent, an antioxidant, an anti-reducing agent, an evaporation accelerator, and a chelating agent.

### <Ink>

An ink of the present disclosure includes a gold nanoparticle-containing composition dispersion (the first gold nanoparticle-containing composition dispersion or the second gold nanoparticle-containing composition dispersion). In addition, the ink is preferably an ink for inkjet recording.

The content (mass %) of the gold nanoparticles in the ink is preferably 0.001 mass % or more and 10 mass % or less, more preferably 0.005 mass % or more and 5 mass % or less with respect to the total mass of the ink. When the content of the gold nanoparticles is less than 0.001 mass %, the ink may hardly express its characteristics such as infrared absorbability. Meanwhile, when the content of the gold nanoparticles is more than 10 mass %, an improving effect on the storage stability of the ink may reduce to some extent. The content of the gold nanoparticles in the ink may be measured by thermogravimetric differential thermal analysis (TG-DTA).

The same dispersion medium as that incorporated into the above-mentioned gold nanoparticle-containing composition dispersion may be used as a dispersion medium to be incorporated into the ink. Various additives may each be incorporated into the ink as required. Examples of the additives may include a surfactant, a pH adjuster, a surface slipping agent, a rust inhibitor, an antiseptic, a mildew-proofing agent, an antioxidant, an anti-reducing agent, an evaporation accelerator, and a chelating agent.

### <Toner>

A toner of the present disclosure includes a binder resin and a gold nanoparticle-containing composition. The dispersibility of gold nanoparticles in the toner can be improved, and hence the gold nanoparticles can be turned into the toner while their characteristics are maintained.

The toner (first gold nanoparticle-containing toner) of the present disclosure includes the binder resin and the gold nanoparticle-containing composition. In addition, the gold nanoparticle-containing composition is the above-mentioned first gold nanoparticle-containing composition including: the gold nanoparticles; and the compound having a structure represented by any one of the general formulae (1) to (3), the compound having an HLB value of 12 or less. That is, the first gold nanoparticle-containing toner may be obtained by mixing the above-mentioned first gold nanoparticle-containing composition with the binder resin in accordance with an ordinary method.

In addition, the toner (second gold nanoparticle-containing toner) of the present disclosure includes the binder resin and the gold nanoparticle-containing composition. In addition, the gold nanoparticle-containing composition is the above-mentioned second gold nanoparticle-containing composition including: the gold nanoparticles; and the compound having a structure represented by any one of the general formulae (4) to (6). That is, the second gold nanoparticle-containing toner may be obtained by mixing the above-mentioned second gold nanoparticle-containing composition with the binder resin in accordance with an ordinary method.

Examples of the binder resin may include a styrene-acrylic resin, a polyester resin, and an epoxy resin. In addition, two or more kinds of binder resins may be used. The molecular structure of the binder resin may be any one of a linear resin, a branched resin, and a crosslinked resin.

Various additives may each be incorporated into the toner as required. Examples of the additives may include a wax, a charge control agent, and an external additive.

### <Various Measurement Methods and the Like>

### (Recognition of Coordination)

Whether or not the zwitterionic compound or the polymer compound coordinates to the surface of each of the gold nanoparticles may be recognized by infrared absorption spectroscopy (IR). The gold nanoparticle-containing composition may be used as it is as a sample. In addition, in the case of the gold nanoparticle-containing composition dispersion, a product obtained as follows may be used as a sample: a poor solvent is added as required to the dispersion, and the mixture is subjected to centrifugation treatment; and then the produced precipitate is dried. When the IR spectrum of the sample is measured, and a peak characteristic of a bonding portion thereof is observed, it can be judged that the zwitterionic compound or the polymer compound coordinates to the surface of each of the gold nanoparticles.

### (Method of Determining Gold Content)

A gold content in each of the gold nanoparticle-containing composition and the gold nanoparticle-containing composition dispersion may be determined by ICP emission spectroscopy in conformity with JIS K 0116:2014. The gold nanoparticle-containing composition may be used as it is as a sample, and its gold content may be determined by the ICP emission spectroscopy. In addition, in the case of the gold nanoparticle-containing composition dispersion, first, the dispersion is heated with a hot plate or the like to provide dry matter. Next, aqua regia is added to the resultant dry matter, and then the mixture is subjected to microwave acid decomposition with a microwave sample pretreatment apparatus (product name: “ETHOS PRO”, manufactured by Milestone General K.K.) or the like to provide a liquid. After that, the resultant liquid is subjected to ICP emission spectroscopic analysis with an ICP emission spectroscopic analyzer (e.g., an analyzer available under the product name “CIROS CCD” (manufactured by SPECTRO Analytical Instruments GmbH)). Thus, the gold content can be determined.

### (Measurement of Weight-Average Molecular Weight of Polymer Compound)

The weight-average molecular weight of the polymer compound may be calculated by gel permeation chromatography (GPC) in terms of monodisperse polymethyl methacrylate. The measurement of the weight-average molecular weight by the GPC may be performed, for example, as described below.

A sample is added to the following eluent so that its concentration may be adjusted to 1 mass %. The resultant is left at rest at room temperature (25° C.) for 24 hours to provide a solution. A product obtained by filtering the solution with a solvent-resistant membrane filter having a pore diameter of 0.45 m is used as a sample, and the sample is analyzed in accordance with the following conditions. At the time of the calculation of a molecular weight distribution, a molecular weight calibration curve produced with a standard polymethyl methacrylate resin (product name: “EasiVial PM Polymer Standard Kit”, manufactured by Agilent Technologies, Inc.) is used.

| Apparatus: | Agilent 1260 infinity system (manufactured | |
|---|---|---|
| | by Agilent Technologies, Inc.) | |
| Column: | PFG analytical linear M columns (manufactured | |
| | by Precision System Science Co., Ltd.) | |
| Eluent: | 2,2,2-trifluoroethanol | |
| Flow rate: | 0.2 | mL/min |
| Oven temperature: | 40° | C. |
| Sample injection | 20 | μL |
| amount: | | |

### EXAMPLES

The present disclosure is described in more detail below by way of Examples and Comparative Examples. However, the present disclosure is by no means limited by the following Examples as long as modifications thereof do not deviate from the gist thereof. The terms “part(s)” and “%” representing component amounts are “part(s) by mass” and “mass %”, respectively unless otherwise stated.

### Examples 1 to 18, and Comparative Examples 1 and 2

### <Preparation of Gold Nanoparticle Dispersion>

### (Gold Nanoparticle Dispersion A)

500 Milliliters of a 0.0005 mol/L aqueous solution of chloroauric acid tetrahydrate (manufactured by Kishida Chemical Co., Ltd.) and 500 mL of a 0.2 mol/L aqueous solution of cetyltrimethylammonium bromide (manufactured by Kishida Chemical Co., Ltd.) were mixed. Next, 60 mL of 0.01 mol/L sodium borohydride (manufactured by Tokyo Chemical Industry Co., Ltd.) was added to the mixture to provide a solution A serving as a seed particle solution.

10 Grams of cetyltrimethylammonium bromide was dissolved in 500 mL of a 0.15 mol/L aqueous solution of benzyldimethylhexadecylammonium chloride (manufactured by Tokyo Chemical Industry Co., Ltd.). 20 Milliliters of a 0.004 mol/L aqueous solution of silver nitrate was added to the solution, and then 500 mL of a 0.001 mol/L aqueous solution of chloroauric acid tetrahydrate was further added thereto. Next, 7 mL of a 0.078 mol/L aqueous solution of L-ascorbic acid (manufactured by Kishida Chemical Co., Ltd.) was added to the mixture to provide a solution B.

10 Grams of cetyltrimethylammonium bromide was dissolved in 500 mL of a 0.15 mol/L aqueous solution of benzyldimethylhexadecylammonium chloride (manufactured by Tokyo Chemical Industry Co., Ltd.). 20 Milliliters of a 0.004 mol/L aqueous solution of silver nitrate was added to the solution, and then 500 mL of a 0.0005 mol/L aqueous solution of chloroauric acid tetrahydrate was further added thereto. Next, 3.6 mL of a 0.078 mol/L aqueous solution of L-ascorbic acid (manufactured by Kishida Chemical Co., Ltd.) was added to the mixture to provide a solution C.

1.2 Milliliters of the solution A was dropped into the solution B, and then 2.0 mL of the solution C was added at a rate of 1.0 mL/20 minutes to the mixture to anisotropically grow seed particles serving as cores. The resultant was centrifuged at 10,000×g for 5 minutes, and then separated gold nanoparticles were redispersed in water so that their content became 0.04%. Thus, a gold nanoparticle dispersion A was obtained. The gold nanoparticles in the resultant gold nanoparticle dispersion A were gold nanorods, and had an aspect ratio (average) of 6.

### (Gold Nanoparticle Dispersion B)

A gold nanoparticle dispersion B was obtained in the same manner as in the case of the above-mentioned gold nanoparticle dispersion A except that the amount of the solution C was changed to 25.0 mL. Gold nanoparticles in the resultant gold nanoparticle dispersion B were gold nanorods, and had an aspect ratio (average) of 13.

### (Gold Nanoparticle Dispersion C)

While 300 mL of a 0.00026 mol/L aqueous solution of chloroauric acid tetrahydrate (manufactured by Kishida Chemical Co., Ltd.) was stirred, 10 mL of 0.029 mol/L sodium borohydride was added thereto. The mixture was subjected to a reaction for 24 hours to provide a gold nanoparticle dispersion C. Gold nanoparticles in the resultant gold nanoparticle dispersion C were gold nanospheres, and had an average particle diameter of 14 nm.

### <Production and Preparation of Zwitterionic Compound>

(Compound “a”)

100 Parts of 2-hexadecanol, 73 parts of triethylamine, and 3,000 parts of toluene were mixed, and the mixture was cooled to 0° C. While the mixture was stirred, 79 parts of 2-chloro-1,3,2-dioxaphospholane-2-oxide was dropped thereinto. The mixture was held at 0° C. for 15 minutes, and then its temperature was increased to room temperature, followed by stirring for 4 hours. The produced precipitate was filtered out, and the solvent was evaporated under reduced pressure. Thus, a product was obtained. The resultant product was dissolved in 2,700 parts of acetonitrile, and then 491 parts of triethylamine was added to the solution while the solution was cooled in a dry ice-acetone bath. The mixture was stirred at 70° C. for 48 hours, and was then diluted with methanol. The diluted product was purified by column chromatography to provide a compound “a” having a structure represented by the general formula (1).

(Compound “b”)

A compound “b” having a structure represented by the general formula (1) was obtained in the same manner as in the case of the above-mentioned compound “a” except that 59 parts of 2-nonanol was used instead of 100 parts of 2-hexadecanol.

(Compound “c”)

63 Parts of 2-(benzyloxy)ethanol and 73 parts of triethylamine were mixed in 3,000 parts of toluene, and the mixture was cooled to 0° C. While the mixture was stirred, 79 parts of 2-chloro-1,3,2-dioxaphospholane-2-oxide was dropped thereinto. The mixture was held at 0° C. for 15 minutes, and its temperature was increased to room temperature, followed by stirring for 4 hours. The precipitate was filtered out, and the solvent was evaporated under reduced pressure. The resultant residue was dissolved in 2,700 parts of acetonitrile, and 491 parts of triethylamine was added to the solution while the solution was cooled in a dry ice-acetone bath. The mixture was stirred at 70° C. for 48 hours, and was then diluted with methanol. The diluted product was purified by column chromatography, and then the product was dissolved in 2,700 parts of methanol, followed by the addition of 10 parts of palladium/carbon (10%) thereto. The mixture was stirred under a hydrogen atmosphere for 4 hours. The mixture was filtered, and the solvent was evaporated under reduced pressure. 3,000 Parts of anhydrous dimethylformamide and 250 parts of nonanoic acid were mixed into the residue, and 326 parts of N,N′-dicyclohexylcarbodiimide and 193 parts of 4-dimethylaminopyridine were added to the mixture at 0° C. The temperature of the mixture was increased to room temperature, and the mixture was stirred for 12 hours. The mixture was diluted with methanol and purified by column chromatography to provide a compound “c” having a structure represented by the general formula (1).

(Compound “d”)

2-(Methacryloyloxy)ethyl 2-(trimethylammonio)ethyl phosphate having a structure represented by the general formula (1) (manufactured by Tokyo Chemical Industry Co., Ltd.) was prepared as a compound “d”.

The structures and characteristics of the compounds “a” to “d” are shown in Table 1. In Table 1, X represents a bonding moiety between A₁ and R₁, and X′ represents a bonding moiety between A₁ and a phosphoric acid ester moiety. In addition, Y represents a bonding moiety between A₂ and the phosphoric acid ester moiety, Y′ represents a bonding moiety between A₂ and a quaternary ammonium cation moiety, and Z represents a bonding moiety between R₁ and A₁.

TABLE 1
Structures and characteristics of zwitterionic compounds “a” to “d”

| | |
|---|---|
| General formula (1) | HLB |

| | R₁ | R₂ | R₃ | R₄ | A₁ | A₂ | value |
|---|---|---|---|---|---|---|---|
| Zwitterionic compound “a” | 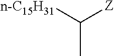 | CH₃ | CH₃ | CH₃ | — | Y—CH₂—CH₂—Y′ | 9 |
| Zwitterionic compound “b” | 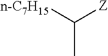 | CH₃ | CH₃ | CH₃ | — | Y—CH₂—CH₂—Y′ | 12 |
| Zwitterionic compound “c” | n-C₈H₁₇-Z | CH₃ | CH₃ | CH₃ | 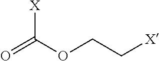 | Y—CH₂—CH₂—Y′ | 11 |
| Zwitterionic compound “d” | 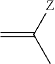 | CH₃ | CH₃ | CH₃ | 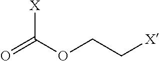 | Y—CH₂—CH₂—Y′ | 13 |

(Compound “e”)

Octadecyldimethyl(3-sulfopropyl)ammonium hydroxide inner salt having a structure represented by the general formula (2) (manufactured by Tokyo Chemical Industry Co., Ltd.) was prepared as a compound “e”. The structure and characteristic of the compound “e” are shown in Table 2. In Table 2, X represents a bonding moiety between R₅ and A₃, Y represents a bonding moiety between A₄ and a quaternary ammonium cation moiety, and Y′ represents a bonding moiety between A₄ and SO₃⁻.

TABLE 2
Structure and characteristic of zwitterionic compound “e”

| | General formula (2) | | | | | | HLB |
|---|---|---|---|---|---|---|---|
| | R₅ | R₆ | R₇ | A₃ | A₄ | Y⁻ | value |
| Zwitterionic | X—(CH₂)₁₇—CH₃ | CH₃ | CH₃ | — | Y—(CH₂)₃—Y′ | SO₃⁻ | 8 |
| compound “e” | | | | | | | |

### <Production of Polymer Compound>

(Polymer Compound “a”)

A reaction vessel mounted with a cooling tube, a stirring machine, a temperature gauge, and a nitrogen-introducing tube was prepared. 17.9 Parts of 2-(methacryloyloxy)ethyl 2-(trimethylammonio)ethyl phosphate, 82.1 parts of octadecyl methacrylate, 4.1 parts of azobisisobutyronitrile, and 900 parts of n-butanol were loaded into the reaction vessel. The mixture was subjected to bubbling with a nitrogen gas for 30 minutes, and was then heated at 65° C. for 8 hours so that its polymerization reaction was completed. The resultant was cooled to room temperature, and then a pressure therearound was reduced, followed by the evaporation of the solvent. The resultant residue was dissolved in methanol, and the solution was purified by dialysis with a dialysis membrane (product name: “Spectra/Por 7 MWCO 1 kDa”, manufactured by Spectrum Laboratories, Inc.). The solvent was evaporated under reduced pressure, and then the residue was dried under a reduced pressure of 0.1 kPa or less at 50° C. to provide a polymer compound “a” having a structure represented by the general formula (4). It was recognized that the content of a unit represented by the general formula (7) in the resultant polymer compound “a” was 79 mol % with respect to all units.

(Polymer Compound “b”)

A polymer compound “b” having a structure represented by the general formula (4) was obtained in the same manner as in the case of the above-mentioned polymer compound “a” except that 27.7 parts of ethyl methacrylate was used instead of 82.1 parts of octadecyl methacrylate.

(Polymer Compound “c”)

The amount of 2-(methacryloyloxy)ethyl 2-(trimethylammonio)ethyl phosphate was changed to 89.5 parts, and 8.6 parts of butyl methacrylate was used instead of 82.1 parts of octadecyl methacrylate. Further, 900 parts of 2,2,2-trifluoroethanol was used instead of 900 parts of n-butanol. A polymer compound “c” having a structure represented by the general formula (4) was obtained in the same manner as in the case of the above-mentioned polymer compound “a” except the foregoing.

(Polymer Compound “d”)

89.5 Parts of 2-(methacryloyloxy)ethyl 2-(trimethylammonio)ethyl phosphate was used instead of 17.9 parts of 2-(methacryloyloxy)ethyl 2-(trimethylammonio)ethyl phosphate and 82.1 parts of octadecyl methacrylate. Further, 900 parts of 2,2,2-trifluoroethanol was used instead of 900 parts of n-butanol.

A polymer compound “d” having a structure represented by the general formula (4) was obtained in the same manner as in the case of the above-mentioned polymer compound “a” except the foregoing.

The structures and characteristics of the polymer compounds “a” to “d” are shown in Table 3. In Table 3, X represents a bonding moiety between A₆ and a polymer main chain, and X′ represents a bonding moiety between A₆ and a phosphoric acid ester moiety. In addition, Y represents a bonding moiety between A₉ and the phosphoric acid ester moiety, Y′ represents a bonding moiety between A₉ and a quaternary ammonium cation moiety, and Z represents a bonding moiety between R₂₆ and the polymer main chain.

TABLE 3
Structures and characteristics of polymer compounds “a” to “d”

| | | | | | | | | Composition ratio |
|---|---|---|---|---|---|---|---|---|
| | | | | | | | | (molar ratio) |
| | | | | | | | | General formula |
| | General formula (4) | | | | | General formula (7) | | (4): General formula |
| | R₁₂ | R₁₃ | R₁₄ | A₆ | A₇ | R₂₅ | R₂₆ | (7) |
| Polymer com- pound “a” | CH₃ | CH₃ | CH₃ | 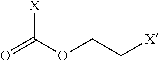 | Y—CH₂—CH₂—Y′ | CH₃ | 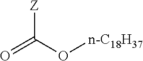 | 21:79 |
| Polymer com- pound “b” | CH₃ | CH₃ | CH₃ | 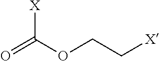 | Y—CH₂—CH₂—Y′ | CH₃ | 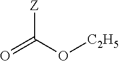 | 20:80 |
| Polymer com- pound 37c” | CH₃ | CH₃ | CH₃ | 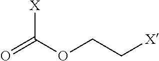 | Y—CH₂—CH₂—Y′ | CH₃ | 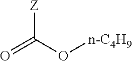 | 80:20 |
| Polymer com- pound “d” | CH₃ | CH₃ | CH₃ | 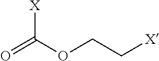 | Y—CH₂—CH₂—Y′ | — | — | 100:0 |

(Polymer Compound “e”)

42.3 Parts of 3-[[2-(methacryloyloxy)ethyl]dimethylammonio]propane-1-sulfonate was used instead of 17.9 parts of 2-(methacryloyloxy)ethyl 2-(trimethylammonio)ethyl phosphate. In addition, 25.8 parts of hexyl methacrylate was used instead of 82.1 parts of octadecyl methacrylate. Further, 900 parts of 2,2,2-trifluoroethanol was used instead of 900 parts of n-butanol. A polymer compound “e” having a structure represented by the general formula (5) was obtained in the same manner as in the case of the above-mentioned polymer compound “a” except the foregoing.

(Polymer Compound “f”)

32.6 Parts of 2-[[2-(methacryloyloxy)ethyl]dimethylammonio]acetate was used instead of 17.9 parts of 2-(methacryloyloxy)ethyl 2-(trimethylammonio)ethyl phosphate. In addition, 25.8 parts of hexyl methacrylate was used instead of 82.1 parts of octadecyl methacrylate. Further, 900 parts of 2,2,2-trifluoroethanol was used instead of 900 parts of n-butanol. A polymer compound “f” having a structure represented by the general formula (5) was obtained in the same manner as in the case of the above-mentioned polymer compound “a” except the foregoing.

The structures and characteristics of the polymer compounds “e” and “f” are shown in Table 4. In Table 4, X represents a bonding moiety between A₈ and a polymer main chain, and X′ represents a bonding moiety between A₈ and a quaternary ammonium cation moiety. Y represents a bonding moiety between A₉ and the quaternary ammonium cation moiety, Y′ represents a bonding moiety between A₉ and SO₃⁻ or CO₂⁻, and Z represents a bonding moiety between R₂₆ and the polymer main chain.

TABLE 4
Structures and characteristics of polymer compounds “e” and “f”

| | General formula (5) | | | | | General formula (7) | | Composition ratio |
|---|---|---|---|---|---|---|---|---|
| | R₁₅ | R₁₆ | A₈ | A₉ | Y′ | R₂₅ | R₂₆ | (molar ratio) |
| Polymer compound “e” | CH₃ | CH₃ | 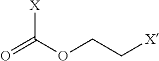 | Y—(CH₂)₃—Y′ | SO₃⁻ | CH₃ | 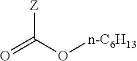 | 50:50 |
| Polymer compound “f” | CH₃ | CH₃ | 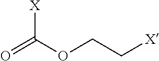 | Y—CH₂—Y′ | COO⁻ | CH₃ | 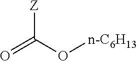 | 50:50 |

### <Production of Gold Nanoparticle-Containing Composition Dispersion>

### (Preparation of Aqueous Solution of Zwitterionic Compound)

5 Parts of each of the zwitterionic compounds and 95 parts of ion-exchanged water were loaded into a vessel including a stirring machine and a temperature gauge, and the temperature of the mixture was increased to 80° C. The mixture was heated as it was for 5 minutes. After the recognition of the complete dissolution of the zwitterionic compound, the solution was cooled to room temperature to provide each of aqueous solutions of the zwitterionic compounds “a” to “e”.

### (Preparation of Aqueous Solution of Polymer Compound)

5 Parts of each of the polymer compounds and 95 parts of ion-exchanged water were loaded into a vessel including a stirring machine and a temperature gauge, and the temperature of the mixture was increased to 80° C. The mixture was heated as it was for 5 minutes. After the recognition of the complete dissolution of the polymer compound, the solution was cooled to room temperature to provide each of aqueous solutions of the polymer compounds “a” to “f”.

### (Gold Nanoparticle-Containing Composition Dispersion 1)

100 Parts of the gold nanoparticle dispersion A and 4.2 parts of the aqueous solution of the zwitterionic compound “a” were mixed, and then the mixture was stirred for 3 hours to provide a gold nanoparticle-containing composition dispersion 1.

### (Gold Nanoparticle-Containing Composition Dispersions 2 to 20)

Gold nanoparticle-containing composition dispersions 2 to 20 were each obtained in the same manner as in the case of the above-mentioned gold nanoparticle-containing composition dispersion 1 except that formulation shown in each of Tables 5-1 and 5-2 was adopted.

TABLE 5-1
Compositions and characteristics of gold nanoparticle-containing composition dispersions

| | | Example | | | | | | | | | | |
|---|---|---|---|---|---|---|---|---|---|---|---|---|
| | | 1 | 2 | 3 | 4 | 5 | 6 | 7 | 8 | 9 | 10 | 11 |
| Gold nanoparticle- | | 1 | 2 | 3 | 4 | 5 | 6 | 7 | 8 | 9 | 10 | 11 |
| containing composition | | | | | | | | | | | | |
| dispersion | | | | | | | | | | | | |
| Gold | A | 100 | 100 | 100 | 100 | 100 | 100 | 100 | 100 | 100 | 100 | 100 |
| nanoparticle | B | | | | | | | | | | | |
| dispersion | C | | | | | | | | | | | |
| Aqueous | a | 4.2 | 1 | 0.4 | 0.2 | | | | | | | |
| solution of | b | | | | | 1 | | | | | | |
| zwitterionic | c | | | | | | 1 | | | | | |
| compound | d | | | | | | | | | | | |
| | e | | | | | | | 1 | | | | |
| Aqueous | a | | | | | | | | 4.2 | 1 | 0.4 | 0.2 |
| solution of | b | | | | | | | | | | | |
| polymer | c | | | | | | | | | | | |
| compound | d | | | | | | | | | | | |
| | e | | | | | | | | | | | |
| | f | | | | | | | | | | | |

| | | | | | | | | | | | |
|---|---|---|---|---|---|---|---|---|---|---|---|
| Content of gold | 0.04 | 0.04 | 0.04 | 0.04 | 0.04 | 0.04 | 0.04 | 0.04 | 0.04 | 0.04 | 0.04 |
| nanoparticles (%) | | | | | | | | | | | |
| Content of zwitterionic | 0.2 | 0.05 | 0.02 | 0.01 | 0.05 | 0.05 | 0.05 | | | | |
| compound (%) | | | | | | | | | | | |
| Content of polymer | | | | | | | | 0.2 | 0.05 | 0.02 | 0.01 |
| compound (%) | | | | | | | | | | | |

TABLE 5-2
Compositions and characteristics of dispersions

| | | | | | | | | | Comparative | |
|---|---|---|---|---|---|---|---|---|---|---|
| | | Example | | | | | | | Example | |
| | | 12 | 13 | 14 | 15 | 16 | 17 | 18 | 1 | 2 |
| Gold nanoparticle- | | 12 | 13 | 14 | 15 | 16 | 17 | 18 | 19 | 20 |
| containing composition | | | | | | | | | | |
| dispersion | | | | | | | | | | |
| Gold | A | 100 | 100 | 100 | 100 | 100 | | | 100 | 100 |
| nanoparticle | B | | | | | | 100 | | | |
| dispersion | C | | | | | | | 100 | | |
| Aqueous | a | | | | | | | | | |
| solution of | b | | | | | | | | | |
| zwitterionic | c | | | | | | | | | |
| compound | d | | | | | | | | | 1 |
| | e | | | | | | | | | |
| Aqueous | a | | | | | | 1 | 1 | | |
| solution of | b | 1 | | | | | | | | |
| polymer | c | | 1 | | | | | | | |
| compound | d | | | 1 | | | | | | |
| | e | | | | 1 | | | | | |
| | f | | | | | 1 | | | | |

| | | | | | | | | | |
|---|---|---|---|---|---|---|---|---|---|
| Content of gold | 0.04 | 0.04 | 0.04 | 0.04 | 0.04 | 0.04 | 0.04 | 0.04 | 0.04 |
| nanoparticles (%) | | | | | | | | | |
| Content of zwitterionic | | | | | | | | | 0.05 |
| compound (%) | | | | | | | | | |
| Content of polymer | 0.05 | 0.05 | 0.05 | 0.05 | 0.05 | 0.05 | 0.05 | | |
| compound (%) | | | | | | | | | |

### <Evaluation>

The gold nanoparticle-containing composition dispersions 1 to 20 produced in Examples 1 to 18, and Comparative Examples 1 and 2 were each evaluated for its storage stability as described below.

### (Storage Stability)

100 Grams of each of the gold nanoparticle-containing composition dispersions was loaded into a glass-made closed vessel having a volume of 180 mL, and the vessel was sealed. The vessel was loaded into an oven at a temperature of 80° C., and was stored for 4 days. The absorption spectra of each of the gold nanoparticle-containing composition dispersions 1 to 20 before the storage and after the storage were measured in accordance with the following measurement conditions, and the absorption intensity maintenance ratio thereof was calculated from the following equation (X). Then, the dispersions were each evaluated for its storage stability in accordance with the following evaluation criteria. The results are shown in Table 6.

$$Absorption intensity maintenance ratio ( \% ) = ( {A}_{2} / {A}_{1} ) \times 100 ⋯ ( X )$$

A₁: the absorption intensity of a gold nanoparticle-containing composition dispersion before its storage at the maximum absorption wavelength
A₂: the absorption intensity of the gold nanoparticle-containing composition dispersion after the storage at the maximum absorption wavelength.

### [Conditions for Measurement of Absorption Spectrum]

Measuring apparatus: a UV-visible near-infrared spectrophotometer (product name: “V-670”, manufactured by JASCO Corporation)
Wavelength range: from 400 nm to 1,800 nm.

### [Evaluation Criteria]

A: The absorption intensity maintenance ratio was 70% or more.
B: The absorption intensity maintenance ratio was 50% or more and less than 70%.
C: The absorption intensity maintenance ratio was 10% or more and less than 50%.
D: The absorption intensity maintenance ratio was less than 10%.

TABLE 6
Evaluation

| | | Gold nanoparticle-containing | Storage |
|---|---|---|---|
| | | composition dispersion | stability |
| Example | 1 | 1 | A |
| | 2 | 2 | A |
| | 3 | 3 | B |
| | 4 | 4 | C |
| | 5 | 5 | A |
| | 6 | 6 | A |
| | 7 | 7 | A |
| | 8 | 8 | A |
| | 9 | 9 | A |
| | 10 | 10 | A |
| | 11 | 11 | C |
| | 12 | 12 | A |
| | 13 | 13 | A |
| | 14 | 14 | C |
| | 15 | 15 | A |
| | 16 | 16 | B |
| | 17 | 17 | A |
| | 18 | 18 | A |
| Comparative | 1 | 19 | D |
| Example | 2 | 20 | D |

### COMPARATIVE EXAMPLE

### Example 19

### <Production of Toner>

### (Dispersion of Saturated Polyester 1)

The following materials were sufficiently mixed to provide a dispersion of a saturated polyester 1.

| | |
|---|---|
| Saturated polyester 1 (polycondensate of ethylene | 20 parts |
| oxide-added bisphenol A and terephthalic acid, | |
| glass transition temperature: 60° C., weight- | |
| average molecular weight: 29,000, number- | |
| average molecular weight: 6,000): | |
| Toluene: (Toner 1) | 80 parts |

104 Parts of the gold nanoparticle-containing composition dispersion 1 was evaporated under reduced pressure, and 416 parts of the dispersion of the saturated polyester 1 was added to the residue. The mixture was stirred well with a magnetic stirrer, and was dropped into heptane (manufactured by Kishida Chemical Co., Ltd.) to be reprecipitated. The resultant precipitate was recovered by suction filtration to provide a mixture of the gold nanoparticles and the saturated polyester in a powder state. 5 Parts of an ester wax (peak temperature of the highest endothermic peak in DSC measurement=70° C., Mn=704) was added to 100 parts of the resultant mixture, and the materials were sufficiently mixed with a mixer (product name: “FM MIXER”, manufactured by Nippon Coke & Engineering Co., Ltd.). After that, the mixture was melted and kneaded with a twin-screw kneader (product name: “PCM-30”, manufactured by Ikegai Corp) set to a temperature of 150° C. to provide a kneaded product. The resultant kneaded product was expanded in a sheet shape on a water-cooled metal belt to be cooled. After that, the cooled product was coarsely pulverized into a size of 1 mm or less with a hammer mill to provide a coarsely pulverized product. The resultant coarsely pulverized product was finely pulverized with a mechanical pulverizer (product name: “T-250”, manufactured by Freund-Turbo Corporation), and was then classified with a rotary classifier (product name: “200TSP”, manufactured by Hosokawa Micron Corporation) to provide toner particles 1.

100 Parts of the resultant toner particles 1 and 1 part of hydrophobic silica fine powder subjected to surface treatment with hexamethyldisilazane (number-average particle diameter of primary particles: 7 nm) were mixed with a mixer (product name: “FM MIXER”, manufactured by Nippon Coke & Engineering Co., Ltd.) to provide a toner 1.

### Example 20

### (Toner 2)

A toner 2 was obtained in the same manner as in the case of the above-mentioned toner 1 except that the gold nanoparticle-containing composition dispersion 8 was used instead of the gold nanoparticle-containing composition dispersion 1.

### Comparative Example 3

### (Toner 3)

A toner 3 was obtained in the same manner as in the case of the above-mentioned toner 1 except that the gold nanoparticle-containing composition dispersion 19 was used instead of the gold nanoparticle-containing composition dispersion 1.

### <Evaluation>

The toners 1 to 3 produced in Examples 19 and 20, and Comparative Example 3 were each evaluated for its light absorbability as described below.

### (Production of Heat-Fixed Film)

Three SUS plates each having a thickness of 1 cm and a diameter of 5 cm were heated to 100° C. on a hot plate. A pressing machine including a heating mechanism was prepared, and one of the heated SUS plates was mounted on the heating plate of the pressing machine heated to 100° C. A white PET film measuring 5 cm by 5 cm (manufactured by Toray Industries, Inc.) was mounted on the SUS plate, and 2 mg of each of the toners 1 to 3 was mounted on the central portion of the PET film. The remaining two SUS plates were further mounted thereon, and the resultant was pressed at 30 MPa for 30 seconds. The second SUS plate and the PET film were peeled, and the temperature of each of the pressing machine and the hot plate was reduced to 80° C. The PET film to which the toner had been fixed by heating was mounted on the first SUS plate again, and the third SUS plate having applied thereto a release agent (manufactured by Daikin Industries, Ltd.) was mounted thereon. The resultant was pressed at 30 MPa for 30 seconds so that its surface was smoothed. Thus, five sheets each of heat-fixed films 1 to 3 were produced.

### (Light Absorbability in Near-Infrared Region)

The dispersibility of the gold nanoparticles in each of the toners was evaluated by light absorbability in a near-infrared region. The produced heat-fixed films 1 to 3 were each subjected to spectroscopic measurement with a UV-visible near-infrared spectrophotometer (product name: “MV-3300”, manufactured by JASCO Corporation) in the wavelength range of from 900 nm or more to 1,800 nm or less. The maximum value (%) of the reflectance of each of the heat-fixed films was calculated by using the value of the spectroscopic measurement of the white PET film alone as a blank. Then, a value obtained by subtracting the maximum value of the reflectance from 100 was adopted as a light absorptivity (%). The average of the light absorptivities of the five sheets each of the films was adopted as a light absorptivity, and the films were each evaluated for its light absorbability in accordance with the following evaluation criteria. The results are shown in Table 7.

### [Evaluation Criteria]

A: The light absorptivity was 15% or more.
B: The light absorptivity was 10% or more and less than 15%.
C: The light absorptivity was less than 10%.

TABLE 7
Evaluation

| | | | Light absorbability in |
|---|---|---|---|
| | | Toner | near-infrared region |
| Example | 19 | 1 | B |
| | 20 | 2 | A |
| Comparative | 3 | 3 | C |
| Example | | | |

According to the present disclosure, the gold nanoparticle-containing composition excellent in storage stability can be provided.

In addition, according to the present disclosure, the gold nanoparticle-containing composition dispersion excellent in storage stability can be provided. In addition, according to the present disclosure, the ink excellent in storage stability can be provided.

Further, according to the present disclosure, the toner excellent in dispersibility of gold nanoparticles can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A gold nanoparticle-containing composition comprising:
gold nanoparticles; and
a compound having a structure represented by any one of the following general formulae (1) to (3), the compound having an HLB value of 12 or less: 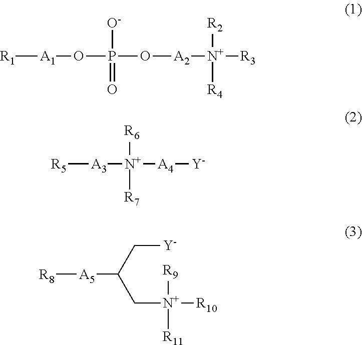
in the general formulae (1) to (3), R₁, R₅, and R₈ each independently represent an organic group, R₂ to R₄, R₆, R₇, and R₉ to R₁₁ each independently represent a hydrogen atom or an alkyl group, A₁ to A₅ each independently represent a linking group, and Y⁻ represents COO⁻ or SO₃⁻.

2. The gold nanoparticle-containing composition according to claim 1, wherein at least part of the compound coordinates to a surface of each of the gold nanoparticles.

3. The gold nanoparticle-containing composition according to claim 1, wherein the gold nanoparticles are gold nanorods.

4. A gold nanoparticle-containing composition comprising:
gold nanoparticles; and
a polymer compound having a structure represented by any one of the following general formulae (4) to (6): 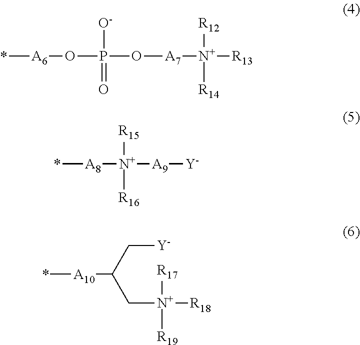
in the general formulae (4) to (6), R₁₂ to R₁₉ each independently represent a hydrogen atom or an alkyl group, A₆ to A₁₀ each independently represent a linking group, Y⁻ represents COO⁻ or SO₃⁻, and * represents a bonding site to a polymer main chain.

5. The gold nanoparticle-containing composition according to claim 4, wherein at least part of the polymer compound coordinates to a surface of each of the gold nanoparticles.

6. The gold nanoparticle-containing composition according to claim 4, wherein the polymer compound has a polymer main chain including a unit represented by the following general formula (7): 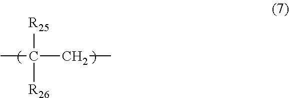
in the general formula (7), R₂₅ represents a hydrogen atom or an alkyl group, and R₂₆ represents an alkyl group, a carboxylic acid ester group, a carboxylic acid amide group, an alkoxy group, or an aryl group.

7. The gold nanoparticle-containing composition according to claim 4, wherein the gold nanoparticles are gold nanorods.

8. A gold nanoparticle-containing composition dispersion comprising:
a dispersion medium; and
a gold nanoparticle-containing composition dispersed in the dispersion medium,
wherein the gold nanoparticle-containing composition includes gold nanoparticles and a compound having a structure represented by any one of the following general formulae (1) to (3), the compound having an HLB value of 12 or less: 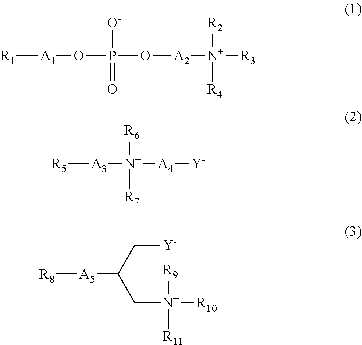
in the general formulae (1) to (3), R₁, R₅, and R₈ each independently represent an organic group, R₂ to R₄, R₆, R₇, and R₉ to R₁₁ each independently represent a hydrogen atom or an alkyl group, A₁ to A₅ each independently represent a linking group, and Y⁻ represents COO⁻ or SO₃⁻.

9. A gold nanoparticle-containing composition dispersion comprising:
a dispersion medium; and
a gold nanoparticle-containing composition dispersed in the dispersion medium,
wherein the gold nanoparticle-containing composition includes gold nanoparticles and a polymer compound having a structure represented by any one of the following general formulae (4) to (6): 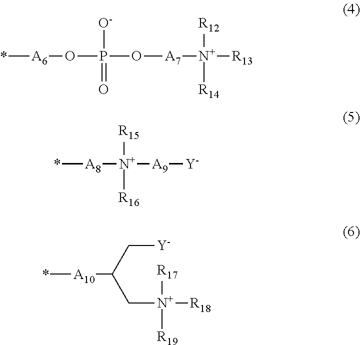
in the general formulae (4) to (6), R₁₂ to R₁₉ each independently represent a hydrogen atom or an alkyl group, A₆ to A₁₀ each independently represent a linking group, Y⁻ represents COO⁻ or SO₃⁻, and * represents a bonding site to a polymer main chain.

10. An ink comprising the gold nanoparticle-containing composition dispersion of claim 8.

11. A toner comprising:
a binder resin; and
a gold nanoparticle-containing composition,
wherein the gold nanoparticle-containing composition includes gold nanoparticles and a compound having a structure represented by any one of the following general formulae (1) to (3), the compound having an HLB value of 12 or less: 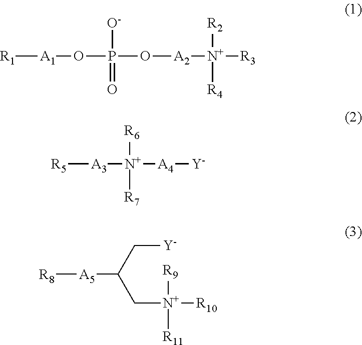
in the general formulae (1) to (3), R₁, R₅, and R₈ each independently represent an organic group, R₂ to R₄, R₆, R₇, and R₉ to R₁₁ each independently represent a hydrogen atom or an alkyl group, A₁ to A₅ each independently represent a linking group, and Y⁻ represents COO⁻ or SO₃⁻.

12. Atoner comprising:
a binder resin; and
a gold nanoparticle-containing composition,
wherein the gold nanoparticle-containing composition includes gold nanoparticles and a polymer compound having a structure represented by any one of the following general formulae (4) to (6): 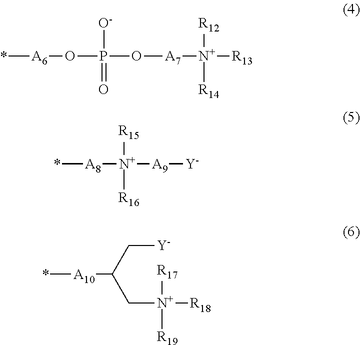
in the general formulae (4) to (6), R₁₂ to R₁₉ each independently represent a hydrogen atom or an alkyl group, A₆ to A₁₀ each independently represent a linking group, Y⁻ represents COO⁻ or SO₃⁻, and * represents a bonding site to a polymer main chain.
